(19) United States
(12) Patent Application Publication
(10) Pub. No.: US 2001/0030630 A1
(43) Pub. Date: Oct. 18, 2001

(54) Portable machine display

(75) Inventor: Paul B. Junk, Neuwied (DE)

Correspondence Address: COLLARD & ROE, P.C., 1077 Northern Boulevard, Roslyn, NY, 11576, US

(73) Assignee: Winkler & Dunnebier Aktiengesellschaft

(21) Appl. No.: 09/833,509

(22) Filed: Apr. 12, 2001

(30) Foreign Application Priority Data
Apr. 14, 2000 (DE) 100 18 490.1

(51) Int. Cl. G09G 5/00

(52) U.S. Cl. 345/7

(57) ABSTRACT

A portable terminal for displaying the operating values of a machine. The display of the monitor is in the form of goggles. The goggle lenses display the operating values of the machine while simultaneously allowing the environment to be viewed.

### BACKGROUND OF THE INVENTION

1. Field of the Invention

The invention relates to a portable machine display for operating and displaying operating values of a machine. More specifically, it relates to a terminal that is carried by the operator while moving around the machine.

2. The Prior Art

Conventional terminals typically contain at least one monitor having a control panel. The monitor is located in a central location of a machine.

In the case of very large machines, for example 10 meters in length and more, a few monitors are often distributed over the length of the machine, so that the machine operator can always keep at least one of the monitors within his range of vision irrespective of where he is located along the machine.

Also known are portable terminals which, in addition to displaying the operating condition on a monitor, permit the machine operator to interact with the machine. A keypad is provided on the terminal for this purpose, or the monitor contains a touchscreen.

These portable terminals are marketed by KEBA GmbH of Göttingen under the designation KETOP G 100, and described in greater detail in the sales prospectus.

A disadvantage of fixed terminals is that having multiple terminals is costly. In addition, it is not possible for the machine operator to constantly keep his eyes on the monitors, such as when it is necessary to do work on the machine and the operator has to keep his eyes on the work site. It is difficult in this case to directly observe the effect of a machine adjustment on the operating mode of the machine.

Portable terminals also contain considerable drawbacks. Even though these terminals do reduce the number of monitors required along the machine, the operator still requires the use of his hands for holding the terminals and consequently his hands are no longer free for doing work on the machine. If he takes the terminal out of his hands, it is not always possible for the machine operator to keep the terminal in his range of vision while working on the machine.

### SUMMARY OF THE INVENTION

It is an object of the present invention to provide a portable terminal for operating and displaying the operating values of a machine. The terminal contains a controlling part and a monitor for displaying the operating values. Therefore, the portable terminal is always within the range of vision of the operator, irrespective of his position and line of sight.

These and other objects are accomplished by providing a terminal designed for attachment to the body of the operator. The display of the monitor is always within in the range of vision of the operator.

To assure that the machine data shown on the display is always within the field of vision of the operator, irrespective of the position in which he is keeping his head, the display of the monitor is designed as goggles. The goggles display both the operating values of the machine and allow simultaneous viewing of the environment.

The advantage obtained with the present invention is that the machine operator will always have both the surrounding environment and the displayed machine data in front of his eyes.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

FIG. 1 shows a perspective side view of the portable machine display according to the invention;

FIG. 2 shows another embodiment of the portable display;

FIG. 3 shows another embodiment of the portable display;

FIG. 4 shows a control component; and

FIG. 5 shows another embodiment of the control component.

### DETAILED DESCRIPTION OF THE PREFERRED EMBODIMENT

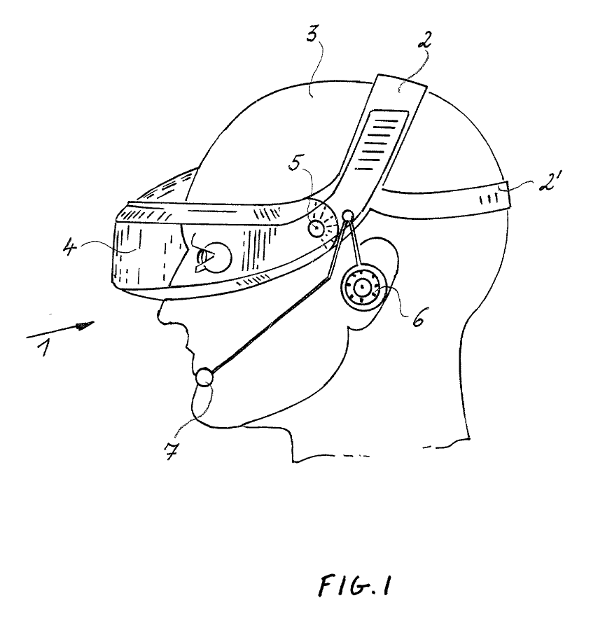

Referring now in detail to the drawings, in particular FIG. 1 shows a monitor 1 in the form of goggles secured by head straps 2 and 2′ to a head 3 of the machine operator. A sight part 4 covers the eyes of the operator. Monitor 1 on which the machine data is displayed, is located in sight part 4. The machine operator can simultaneously keep the environment within his field of vision. Therefore, the operator can walk along the machine without exposing himself to danger while keeping his eyes on the operation of the machine.

In a preferred embodiment, semi-transparent LCD displays are disposed in front of the eyes. These displays are small LCD screens, about the size of stamps, located in front of the eyes of the operator. The display screens show the images or information supplied, while allowing the operator to still view the environment through or behind the images or information in the field of vision. By providing a regulating device, the “degree of transparency” of the displays can be adapted within wide limits, for example the brightness of the ambient light as well as other influences.

According to a second embodiment of the display, an optical combination system is provided for obtaining the “transparency”, for example a semi-mirror. The images of the display and the image of the environment are united in the system and jointly supplied to the eyes of the viewer.

According to a third embodiment, simultaneous viewing of the environment and the images shown on the display is accomplished by having the display arranged only in front of one eye, whereas free “transparency” is available for the other eye to view the surrounding environment.

Finally, in a fourth embodiment, sight component 4 of monitor 1 is slightly folded upwards about a center of rotation 5. This permits the machine operator to view the displays by slightly looking or turning his eyes up, and to see the environment in front of him by slightly lowering the eyes.

The images are shown on the displays in color and are two-dimensional. A three-dimensional form of display is possible if requirements have to be met with respect to information density and clarity. Whereas a monochromatic display can be selected for less stringent requirements.

In addition to the visual display, monitor 1 is provided with an acoustic indicating device in the form of an earphone 6. Earphone 6 is secured to holding strap 2 and located near the ear of the user. Earphone 6 emits a warning sound in the event of any malfunction of the monitored machine. However, it is also possible to use earphone 6 for transmitting operating values of the machine in the form of speech.

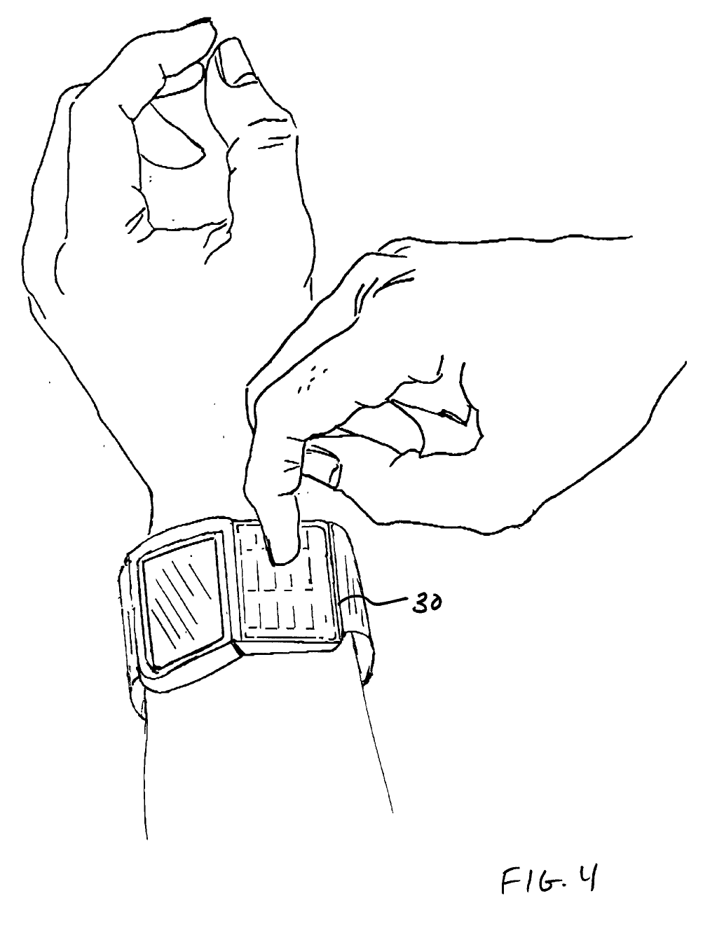

In FIG. 4 control component 30 of the terminal contains a keyboard worn on the wrist like a wrist watch. Monitor 1 is controlled via the keyboard, by selecting the data to be displayed, brightness of the image, degree of transparency of the displays, etc. The machine can also be controlled by the keyboard.

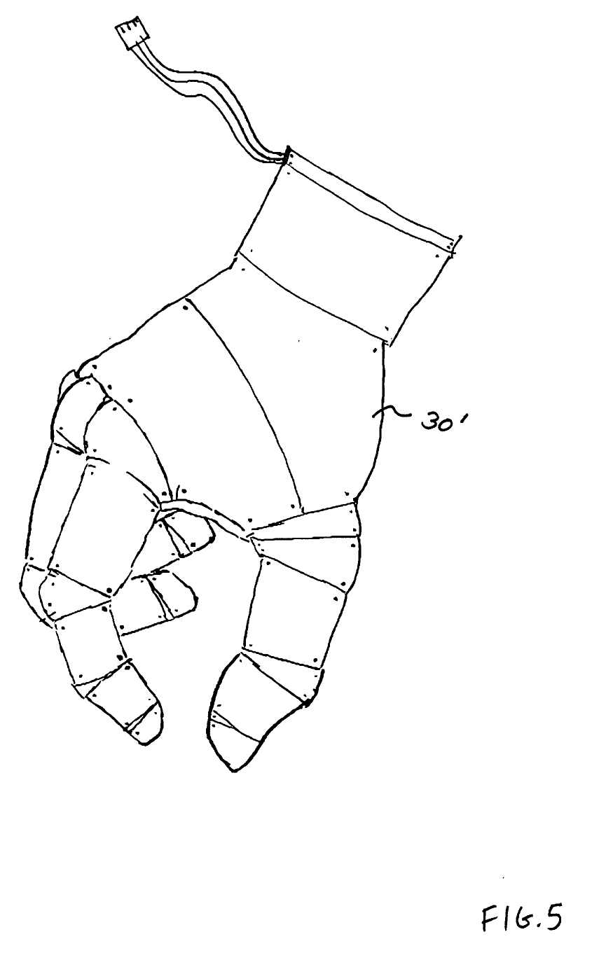

In another embodiment shown in FIG. 5, control component 30′ comprises a touchscreen. Because of the small size of the displays and their arrangement within a pair of goggles, the displays may not be directly accessible to the operator. In this case, a data glove can be provided. This is similar to the mouse pointer on the screen of a PC, wherein a mark is displaced with the help of the data glove by moving it with one or several fingers. A great number of symbols are visible on the display, of which each symbol stands for a defined function. The desired function is activated by touching a symbol with the mark moved by the data glove.

Finally, provision is made for speech control of the machine and monitor. This may be a pure speech control for controlling all functions. However, it is preferably employed for the conventional and slightly slower input of commands via the keyboard, and reserved to just a few, particularly important control commands such as the emergency stop command in the event of malfunction, which is then transmitted instantly by calling it out.

A microphone 7 is secured to holding strap 2 allowing for speech control. This allows the machine to pick up the spoken word of the operator without simultaneously transmitting excessive ambient noise.

The transfer of the data to be displayed from the machine to the terminal or of the control commands from the terminal to the machine is accomplished by electrical pulses transmitted via a wire connection. For this purpose, plug sockets are provided that are spaced apart from each other by a few steps. A connection cable between the machine and the terminal can be plugged into these sockets. The current for the terminal is supplied by the cable as well.

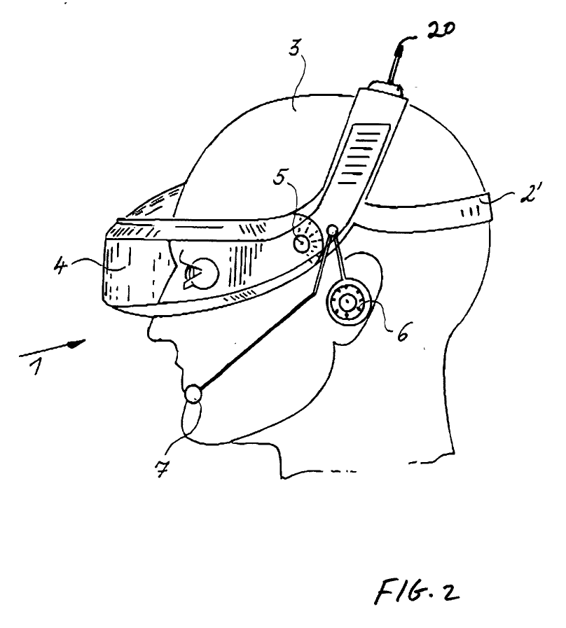

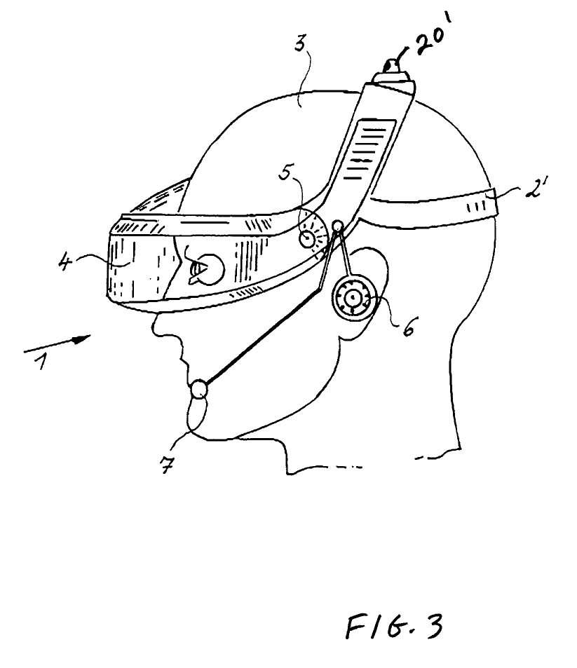

The preferred embodiment allows enhanced freedom of movement of the operator by wirelessly transmitting the data. For this purpose, FIGS. 2 and 3 show a transmitter and receiver 20 is installed on the machine and there is a corresponding receiver and transmitter on the terminal.

FIG. 3 shows a bulb 20′ for transmitting and receiving 1R-light signals.

For wireless data transmission between the terminal and the machine, the terminal is supplied with current by using rechargeable batteries. The batteries are combined in a pack and carried in a separate small casing on the belt of the operator. The transmitter and the receiver of the terminal are also accommodated in the small casing. If the transmitter and the receiver of the terminal are designed as high-frequency devices, the connection cable between the battery casing and the monitor can also be used as an antenna.

Accordingly, while only a few embodiments of the present invention have been shown and described, it is obvious that many changes and modifications may be made thereunto without departing from the spirit and scope of the invention.

What is claimed is:

1. A portable terminal for controlling and displaying operating values of a machine to an operator, comprising:
a control component; and
a monitor for displaying the operating values being attachable to the operator such that the display of the monitor is always in view.

2. The portable terminal according to claim 1, wherein the monitor comprises goggles.

3. The portable terminal according to claim 2, wherein said goggles allow simultaneous viewing of the operating values of the machine and a surrounding environment.

4. The portable terminal according to claim 3, wherein said goggles comprise a semi-transparent display arranged in front of each eye of the operator.

5. The portable terminal according to claim 3, wherein said goggles comprise an optical combination system disposed in said goggles, said combination system receiving both the images on the display and the image of the environment within the line of sight and jointly supplying these images to the eyes of the operator.

6. The portable terminal according to claim 3, wherein said displays are arranged slightly folded upwards, such that the displays are in the field of vision when looking slightly up, and that the view of the environment is clear when the eyes are slightly lowered.

7. The portable terminal according to claim 2, wherein said goggles provide a three-dimensional image.

8. The portable terminal according to claim 3, wherein said goggles comprise two sides, wherein one side is transparent and a second side contains the display.

9. The portable terminal according to claim 1, wherein the control component comprises a keyboard securable to a wrist of the operator.

10. The portable terminal according to claim 1, wherein the control component comprises a data glove.

11. The portable terminal according to claim 1, further comprising a transmitter and a receiver for wireless transmission of data from the machine to the terminal.

12. The portable terminal according to claim 11, wherein said transmitter and said receiver comprise infrared devices.

13. The portable terminal according to claim 11, wherein said transmitter and said receiver comprise high-frequency devices.

14. The portable terminal according to claim 1, further comprising an electroacoustic converter placeable near an ear of the operator for acoustic output of the operating values of the machine and for a warning signal in the event of malfunctioning of the machine.

15. The device according to claim 14, wherein said acoustic output of the operating values of the machine is voice activated.

16. The portable terminal according to claim 1, further comprising a microphone for controlling the monitor and the machine by voice control.
